(19) United States
(12) Patent Application Publication
(10) Pub. No.: US 2009/0321459 A1
(43) Pub. Date: Dec. 31, 2009

(54) Splatter shield for range top burner

(76) Inventors: John R. Maczko, Brighton, MI (US); Kirk E. Neet, Saline, MI (US)

Correspondence Address: KIRK E. NEET, 361 Dogwood CT., Saline, MI, 48176, US

(21) Appl. No.: 12/215,763

(22) Filed: Jun. 30, 2008

(51) Int. Cl. A47J 37/06

(52) U.S. Cl. 220/731

(57) ABSTRACT

Disclosed herein is a splatter shield. The splatter shield includes an upper shield, a lower shield disposed underneath the upper shield, and an opening in the upper shield. The lower shield is inverted from the upper shield.

### BACKGROUND OF THE INVENTION

Cooking foods in a frying pan on a range top oven is very common. The flying pan is typically a shallow pan that is used to fry, saute or sear foods. The range tops typically consist of a plurality of burners which are typically fueled by electricity or natural gas. The user cooks the food by activating the burners after placing the food in the frying pan and the frying pan onto the burner. A problem arises when some common food items, such as oil, butter or grease, become hot and splatter out of the frying pan and consequently create a mess on the range top which is difficult to clean. The simple solution may initially appear to be to place a lid on the frying pan, but two desirable traits of a frying pan make a lid undesirable; 1) a lid does not allow air into the food which a lot of foods need for proper cooking and 2) a lid does not allow the user to easily stir the food as is often desirable when cooking.

Conventional frying pans lack a convenient method of containing the splatter and preventing the range top becoming a mess. Some splatter containment devices have been invented in the past but they are either very cumbersome, do not clean easily, do not store easily (when not in use), do not easily fit on various sizes of pans or do not allow the user to stir the food without removing the splatter shield.

Accordingly, there is a need for a splatter shield that contains the grease, allows the user to easily stir the food, is easy to clean, stores conveniently and can be fitted easily to different size frying pans.

### BRIEF SUMMARY OF THE INVENTION

Disclosed herein is a splatter shield that sits on a frying pan as the frying pan is used to cook foods. The splatter shield consists of two bowl-like members which are temporarily affixed to each other in an inverted manner. The upper shield and lower shield have a scallop cut out of each one in the front of the shield to allow the user to stir foods as they are cooking foods in the frying pan. The lower shield is shorter than the upper shield and the lower shield sits on the top edge of the frying pan. The upper and lower shields are typically formed of a metal material to be able to withstand the heat.

The two bowl-like shields are easily detachable from each other such that the lower shield can be flipped and nested into the upper shield for ease of storage.

### BRIEF DESCRIPTION OF THE DRAWINGS

Referring to the drawings wherein like elements are numbered alike in the several Figures:

FIG. 1 depicts an ISO view of the splatter shield sitting on a frying pan;

FIG. 2 depicts an ISO view of the upper bowl-like member of the splatter shield;

FIG. 3 depicts an ISO view of the lower bowl-like member of the splatter shield;

FIG. 4 depicts an ISO view of the lower bowl-like member flipped and stored within the upper bowl-like member; and

FIG. 5 depicts the splatter shield of FIG.1 sitting on a smaller frying pan.

### DETAILED DESCRIPTION OF THE INVENTION

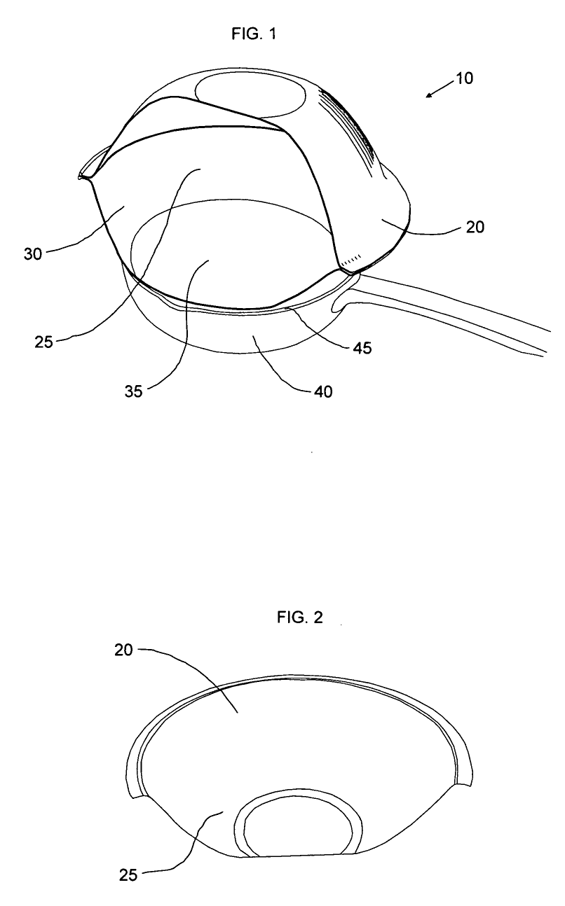

FIG. 1 illustrates an ISO view of the splatter shield 10. The upper shield 20 sits on top of the inverted lower shield 30 which sits on the top edge 45 of a frying pan 40. A large opening 25 appears at the front of the upper shield 20 and a large opening 35 appears at the front of the lower shield 30 so that the user can easily stir the food without disturbing the splatter shield 10. The lower shield 30 is inverted to allow the splatter shield 10 to rest on the frying pan 40 without falling into the frying pan 40 or off of the frying pan 40.

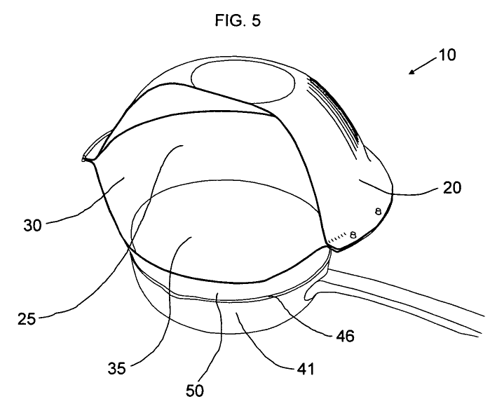

Another advantage of having the lower shield 30 inverted is that it easily allows the same splatter shield 10 to sit in and therefore be utilized with different size pans. This can be seen in FIG. 5 wherein the same splatter shield 10 of FIG. 1 now sits on a smaller frying pan 40. Another aspect best seen in FIG. 1 is that the lower shield 30 is shorter (in vertical height off of the frying pan 40) than the upper shield 20 to allow the user easy access to stir the food in the frying pan 40.

Now referring to FIG. 2, the upper shield 20 is shown separately and inverted (for ease of description). The upper shield 20 resembles the shape of a mixing bowl with a large opening 25 positioned in the front of the upper shield 20. This large opening 25 allows the user to stir the food without disturbing the splatter shield 10. The upper shield 20 is made of a high temperature capable material—typically a metal material such as steel, copper, stainless steel or aluminum. Stainless steel and aluminum are desirable for their non-corrosive benefits. Copper is desirable for its appealing aesthetics. Furthermore it is desirable to make the upper shield 20 and the lower shield 30 out of thin sheet metal to one prevent the splatter shield 10 from absorbing a large quantity of heat and thereby effecting the cooking (and cooking time) of the food. A splatter shield 10 formed of thin sheet metal is also inexpensive to produce and will have minimal mass. The inside of the upper shield 20 and/or lower shield 30 may be coated with a non-stick material to ease cleaning of the splatter shield 10.

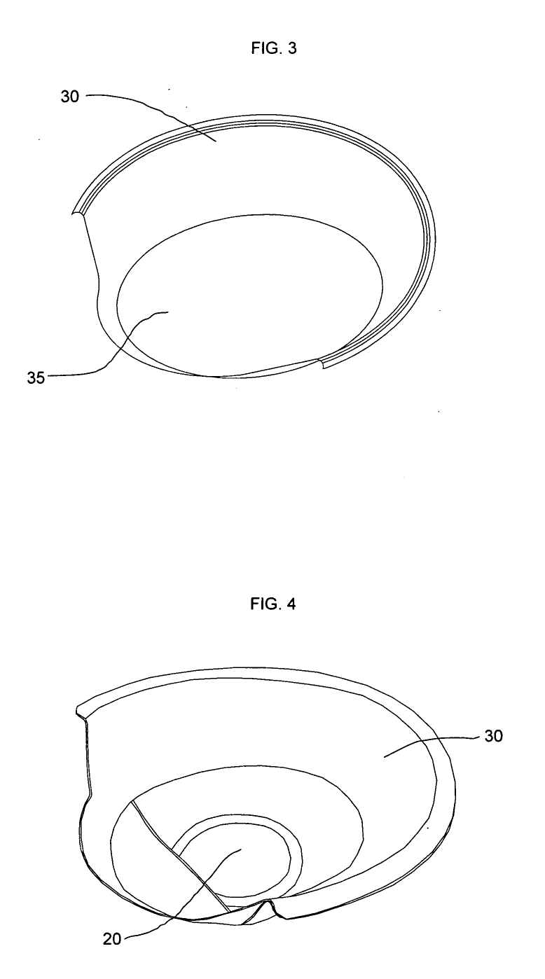

Now referring to FIG. 3, the lower shield 30 is shown separately. Similar to the upper shield 20, the lower shield 30 resembles a shape of a mixing bowl with a large opening 35 positioned in the front of the lower shield 30. This large opening 35 also enables the user to stir the food without disturbing the splatter shield 10. The lower shield 30 is also made of a high temperature capable material—typically a metal material such as, but not limited to, steel, stainless steel or aluminum. The inside of the lower shield may also be coated with a non-stick material to ease cleaning of the splatter shield 10.

Referring back to FIG. 1, the upper shield 20 is shown together with the lower shield 30 to form the splatter shield 10. The upper shield 20 and lower shield 30 may be permanently affixed together by rivets, screws, welds or any other attaching methods. However, more desirably, the upper shield 20 and lower shield 30 may be temporary affixed together by a variety of means, such as a snapfit design, a press-fit design or simply a gravity design. For a gravity design, the weight of the upper shield 20 sets the upper shield 20 onto the lower shield and some form of locating device prevents the upper shield from sliding off the lower shield 30. One method to form this location is shown in FIG. 5. A pin 100 is press fit into the lower shield 30 and a hole 110 in the upper shield 20 mates to the pin 100 such that the upper shield 20 is prevented from sliding off the lower shield 30. For simplicity, only two pins are shown but in reality, more pins would be distributed around the circumference of the shields 20 and 30. Another method (not shown) of locating the two shields 20 and 30 involves the same hole 110 in the upper shield 20 but in replace of the press fit pin 100, the lower shield 30 would include a raised portion that is bent upwards to mate with the hole 100 of the upper shield 20. Even another method (not shown) would be to curl the outer lip 130 of the lower shield 30 upward such that the outer lip 120 of the upper shield 20 would sit inside the outer lip 130. The snap fit designs could be very similar to the locate designs of the gravity design except the pin 100 and the hole 110 would be similar size or the outer lip 130 and the outer lip 120 would be similar size to create a snap fit design. For the case wherein the two shields 20 and 30 are temporarily affixed, the two shields 20 and 30 may be disconnected and easily cleaned and stored.

Referring to FIG. 4, the lower shield 30 is shown flipped and stored neatly inside of the upper shield 30. This storage configuration will allow the splatter shield 10 to be conveniently stored in a typical kitchen without using too much space. Also, since the upper shield 20 and the lower shield 30 have a bowl-like shape, the two shields 20 and 30 may easily be stored in a stack of mixing bowls, which are already taking up space in the kitchen cupboard. In this case, the splatter shield 10 almost takes up no space in the kitchen cupboards.

Referring now to FIG. 5, the same splatter shield shown in FIG. 1 is now sitting on a smaller frying pan 41. This frying pan 41 has an upper edge 46 which is much smaller than the upper edge 45 of frying pan 40 shown in FIG. 1. However, due to the curved surface 50 of the lower shield 30, the splatter shield 10 sits on top of frying pan 46 just as easily and just as safely as the splatter shield 10 sat on frying pan 40, even though the upper edge 46 of frying pan 41 is much smaller than the upper edge 45 of flying pan 40. This flexibility allows the splatter shield 10 to be easily utilized (without any modifications) for different size (or even different brands) frying pans such as 40 and 41.

The scope of this description has centered around the term frying pan but the splatter shield 10 can also easily be mated to a sauce pan, dutch oven or any other type of cooking vessel.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A splatter shield to be used with a pan on a stove top burner, comprising:
an upper shield, the upper shield having an opening; and
a lower shield disposed underneath the upper shield, the lower shield being inverted from the upper shield.

2. The splatter shield of claim 1 further including an opening in the front of the lower shield.

3. The splatter shield of claim 1 wherein the lower shield has a bowl-like shape to give it a curved surface which may easily be mated to different sizes of frying pans.

4. The splatter shield of claim 1 wherein at least one inside surface is coated with a non-stick coating.

5. The splatter shield of claim 1 wherein the upper shield is easily detachable from the lower shield.

6. The splatter shield of claim 5 wherein the lower shield is snap-fit to the upper shield.

7. The splatter shield of claim 5 wherein the lower shield is press-fit to the upper shield.

8. The splatter shield of claim 5 wherein the upper shield rests on the lower shield and is held in place by gravity.

9. The splatter shield of claim 8 further including a locator to prevent the upper shield from sliding off the lower shield.

10. The splatter shield of claim 5 wherein the lower shield and upper shield have bowl-like shapes

11. The splatter shield of claim 10 wherein the lower shield and upper shield have substantially the same size of curvature which will allow the lower shield to be flipped and nested with the upper shield for efficient storage.

12. The splatter shield of claim 1 wherein the lower shield is shorter than the upper shield.

13. The splatter shield of claim 1 wherein the upper shield has a bowl-like shape.

14. The splatter shield of claim 1 wherein at least one of the shields is made from thin sheet metal.

15. The splatter shield of claim 1 wherein at least one of the shields is made from aluminum.

16. The splatter shield of claim 1 wherein at least one of the shields is made from stainless steel.

17. The splatter shield of claim 1 wherein at least one of the shields is made from copper.

18. A splatter shield to be used with a pan on a stove top burner, comprising:
an upper shield formed from a thin sheet metal and having a bowl-like shape; and
a lower shield formed from a thin sheet metal, having a bowl-like shape and being inverted from the upper shield.

19. The splatter shield of claim 18 wherein the lower shield and upper shield have substantially the same size of curvature which will allow the lower shield to be flipped and nested with the upper shield for efficient storage.

20. A splatter shield to be used with a pan on a stove top burner, comprising:
an upper shield formed from a thin sheet metal; and
a lower shield formed from a thin sheet metal, being inverted from the upper shield and having substantially the same size allowing the lower shield to be flipped and nested with the upper shield for efficient storage.
